(19) United States
(12) Patent Application Publication
(10) Pub. No.: US 2026/0170785 A1
(43) Pub. Date: Jun. 18, 2026

(54) SUBJECT DETECTION APPARATUS, METHOD EXECUTED BY SUBJECT DETECTION APPARATUS, AND STORAGE MEDIUM

(71) Applicant: CANON KABUSHIKI KAISHA, Tokyo (JP)

(72) Inventor: HIROTAKA OMORI, Kanagawa (JP)

(21) Appl. No.: 19/364,132

(22) Filed: Oct. 21, 2025

(30) Foreign Application Priority Data
Dec. 18, 2024 (JP) 2024-221590

(51) Int. Cl. G06V 10/10; G06V 10/28; G06V 10/60; G06V 10/98

(52) U.S. Cl. CPC G06V 10/16; G06V 10/28; G06V 10/60; G06V 10/993

(57) ABSTRACT

A subject detection apparatus acquires a visible light image including subject; acquires information that is different than the visible light image and relates to the subject; and performs correction on an area that has been affected by an atmospheric obstacle among the visible light image. The subject detection apparatus performs a detection for the subject from the visible light image; and performs a detection for the subject from the information relating to the subject. The subject detection apparatus calculates a degree of reliability for detection results for a subject detection by a first detection unit that has been performed on the visible light image that has been corrected, and a degree of reliability for subject detection by a second detection unit; and identifies the subject based on these detection results, and the degrees of reliability that have been calculated.

### BACKGROUND

### FIELD

The present disclosure relates to a technology in which a subject is detected by a camera and the like.

### DESCRIPTION OF THE RELATED ART

In conventional subject detection apparatuses, subject detection in various environments is desirable. For example, in a case in which there is fog or haze obscuring the subject, the contrast will become low, the visibility will be hindered, and the detection precision for the subject is lowered.

Japanese Patent Laid-Open No. 2006-98614 suggests a method that realizes a high contrast video image. This method calculates a low tone portion and a high tone portion in a luminance correction curve according to a luminance histogram of an image, and calculates a medium tone portion that can be obtained by connecting the endpoint of a low tone side in the high tone portion of the luminance correction curve that has been calculated and the end point of the high tone side in the low tone portion for the luminance correction curve that has been calculated. In addition, this method uses the low tone portion of the luminance correction curve, the medium tone portion of the luminance correction curve, and the high tone portion of the luminance curve that have been calculated, and corrects the luminance level of the image across the entire tone range.

In addition, in relation to subject detection being difficult when only a visible light image is used, in the technology of Japanese Patent Laid-Open No. 2007-255979, an exterior environment such as weather and the like is detected from information that is obtained from a camera and radar. Specifically, this technology determines a degree of reliability for subject detection results based on a weather environment that has been obtained by detection processing for the external environment.

However, Japanese Patent Laid-Open No. 2006-98614 does not at all mention that there is a possibility that the luminance correction processing for images could affect the subject detection processing. That is, in a case in which image correction processing is performed, a new strategy is necessary in order to suitably perform subject detection.

### SUMMARY

The present disclosure provides a technology that is able to suitably perform subject detection.

A subject detection apparatus according to one aspect of the present disclosure comprises: a first acquisition unit configured to acquire a visible light image including subject; a second acquisition unit configured to information that is different than the visible light image and relates to the subject ; a correction unit configured to perform correction on an area that has been affected by an atmospheric obstacle among the visible light image; a first detection unit configured to perform a first detection for the subject from the visible light image; a second detection unit configured to perform a second detection for the subject from the information relating to the subject; a calculating unit configured to calculate a degree of reliability for detection result for the first detection that has been performed on the visible light image that has been corrected, and a degree of reliability for detection result for the second detection; and a subject identifying unit configured to identify the subject based on the detection result for the first detection, the detection result for the second detection, and the degrees of reliability that have been calculated.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of an image capturing system according to a First Embodiment.

FIG. 2 is a flowchart showing operations of a subject detection apparatus.

FIG. 3A shows a video image that is acquired from visible light images, and FIG. 3B shows subject information that is acquired by radar.

FIG. 4A shows a video image of a state in which there is haze, and FIG. 4B shows a histogram of a state in which there is haze.

FIG. 5A, and FIG. 5B show input-output characteristic curves that are used in haze correction.

FIG. 6A shows a video image from when a haze correction function has been turned on, and weak has been selected as the haze correction strength, and FIG. 6B shows a histogram from when a haze correction function has been turned on, and weak has been selected as the haze correction strength.

FIG. 7A shows a video image from when a haze correction function has been turned on, and strong has been selected as the haze correction strength, and FIG. 7B shows a histogram from when a haze correction function has been turned on, and strong has been selected as the haze correction strength.

FIG. 8A shows a video image from before haze correction processing, and FIG. 8B shows a video image after haze correction processing has been executed when the haze correction strength is strong.

FIG. 9 is a flowchart showing degree of reliability calculation processing in the First Embodiment.

FIG. 10A shows subject information that is acquired from a video image for a state in which the subject detection results are low, and FIG. 10B shows subject information that is acquired from radar in a state in which the subject detection results are low.

FIG. 11A shows a video image of a state in which the weather is clear, or haze is weak, and FIG. 11B shows a video image in which strong haze correction processing has been performed.

FIG. 12 is a flowchart showing degree of reliability calculation processing in a Second Embodiment.

### DESCRIPTION OF THE EMBODIMENTS

Below, embodiments of the present disclosure will be explained in detail with reference to the attached figures. Note that the following embodiments do not limit the present disclosure, and in addition, it is not the case that all of the combinations of features that are explained in the present embodiments are indispensable features for solving the present disclosure. The configurations of the embodiments may be suitably modified and changed according to the specifications and each type of condition (usage conditions, usage environment, and the like) of the apparatus to which they are applied. The technical scope of the present disclosure is to be determined by the scope of the claims, and is not limited by the following individual embodiments. In addition, the present disclosure may also be configured by combining portions of each of the embodiments to be described below.

One or more of the functional blocks that are shown in the diagrams to be described below may also be realized by hardware such as an ASIC, a programmable array (PLA), and the like, and may also be realized by a programmable processor such as a CPU, an MPU, and the like executing software. In addition, one or more of the functional blocks may also be realized by a combination of software and hardware. Therefore, in the following explanation, even in cases in which a different functional block is disclosed as the operating subject, the same hardware can also be realized as the operating subject. ASIC is an abbreviation of Application Specific Integrated Circuit. CPU is an abbreviation of Central Processing Unit. MPU is an abbreviation of Micro-Processing Unit. In addition, in the system that is shown below, a memory is used that provides a work area for the processor, and a storage area for the program. The memory includes a RAM, a ROM, and other types of storage apparatuses.

### [First Embodiment]

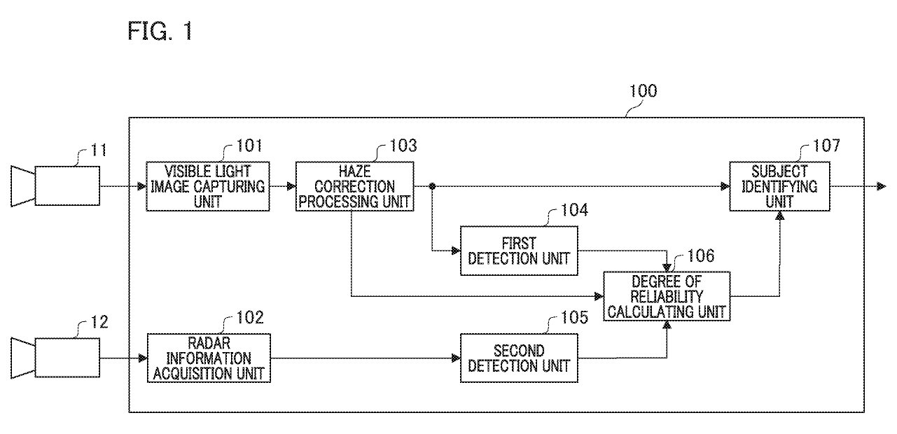

FIG. 1 is a diagram showing an example of a configuration of an image capturing system according to the First Embodiment. This image capturing system includes a visible light camera 11, a radar 12, and a subject detection apparatus 100.

The visible light camera 11 captures images of visible light rays. The visible light camera 11 has an image forming optical system that includes one or more lenses, and a visible light image capturing element (a visible light sensor) that image captures an optical image that has been formed by the image forming optical system, and converts this into a digital signal. The visible light sensor detects visible light rays in a range of wavelengths of, for example from 380nm to 750 nm. The visible light sensor may also have sensitivity in at least a portion of the wavelength area for infrared rays,

The radar 12 is a sensing device configured to measure a subject. Specifically, the radar 12 measures the size, distance, and/or the bearing and the like of a subject. The radar 12 emits microwaves having a short wavelength, and measures the requisite time from the reflected waves, and is thereby able to acquire, for example, the size, distance, and bearing of the subject. In addition, it is also possible to superimpose and associate vessel information and nautical chart data with the subjects that have been measured based on AIS information and GNS. AIS is an abbreviation of Automatic Identification System. GNSS is an abbreviation of Global Navigation Satellite System. As the GNSS there is, for example, GPS, GLONASS, Galileo, BDS, and the like. The size, distance, and/or bearing and the like of the subjects are one example of information relating to subjects. Below, there are cases in which the information relating to a subject is referred to as “subject information”.

The subject detection apparatus 100 includes a visible light image acquisition unit 101, a radar information acquisition unit 102, a haze correction processing unit 103, a first detection unit 104, a second detection unit 105, a degree of reliability calculating unit 106, and a subject identifying unit 107.

The visible light image acquisition unit 101 acquires visible light images that have been captured by the visible light camera 11. The visible light image acquisition unit 101 is one example of a first acquisition unit configured to acquire visible light image including subject.

The radar information acquisition unit 102 acquires subject information that has been measured by the radar 12. There are various subjects such as humans, animals, movable apparatuses (ships, airplanes, automobiles, and the like), buildings, natural objects, and the like. In the following explanation of the present embodiment, for the convenience of referring to the diagrams, an example is used in which the background for the visible light images is made the ocean, and ships, seabirds, and reefs are used as examples of subjects. The radar information acquisition unit 102 is one example of a second acquisition unit configured to acquire information that is different from the visible light image and relates to subject, .

The haze correction processing unit 103 performs correction processing on images in which the contrast value has been decreased based on images that have been acquired from the visible light camera 11. The contrast value is a contrast value (contrast ratio) for the entire image, and a contrast value (contrast ratio) for each partial area of the image. As will be explained below, the processing that is performed by the haze correction processing unit 103 is primarily tone processing (correction processing for the tone). The haze correction processing unit 103 is one example of a correcting unit configured to perform correction on areas that have been affected by an atmospheric obstacle among the visible light image.

The first detection unit 104 detects one or more subjects in the visible light images for which haze correction processing has been performed. Various methods can be applied as the subject detection method, such as for example, a pattern matching method, a method that uses a luminance gradient for within a local area, a method based on machine learning such as deep learning, and the like. The first detection unit 104 is one example of a first detection unit configured to perform a first detection of the subject from the visible light image.

The second detection unit 105 detects one ore more subjects in radar information that is obtained from the radar information acquisition unit 102. The same method as the detection method for the first detection unit 104 may also be used as the subject detection method for the second detection unit. The detection methods for the first detection unit 104 and the second detection unit 105 may also be different. The second detection unit 105 is one example of a second detection unit configured to perform a second detection of subject from information relating to the subject.

The degree of reliability calculating unit 106 calculates a degree of reliability for the subject detection results that have been obtained from the first detection unit 104, and a degree of reliability for the subject detection results that have been obtained from the second detection unit 105.

The subject identifying unit 107 calculates an integrated evaluation value and detects subjects based on primarily the detection results that have been obtained from the first detection unit 104, the detection results that have been obtained from the second detection unit 105, and the degrees of reliability for one or more subjects. Thereby, the subject identifying unit 107 identifies one or more subjects.

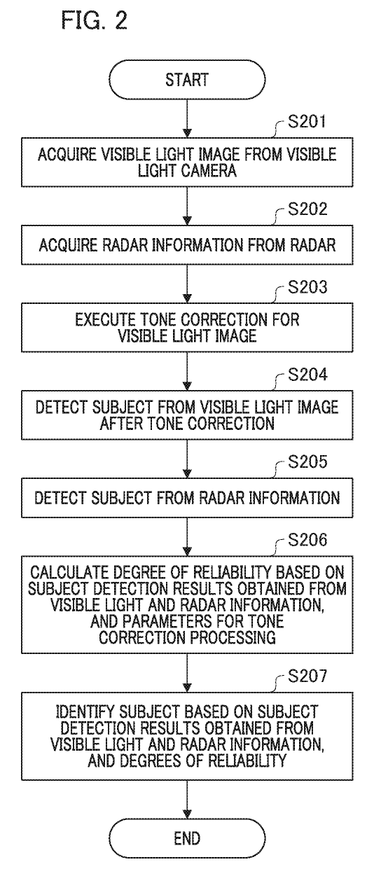

FIG. 2 is a flowchart showing an example of processes for the subject detection apparatus 100. During step S201, the visible light image acquisition unit 101 acquires visible light images that have been captured by the visible light camera 11.

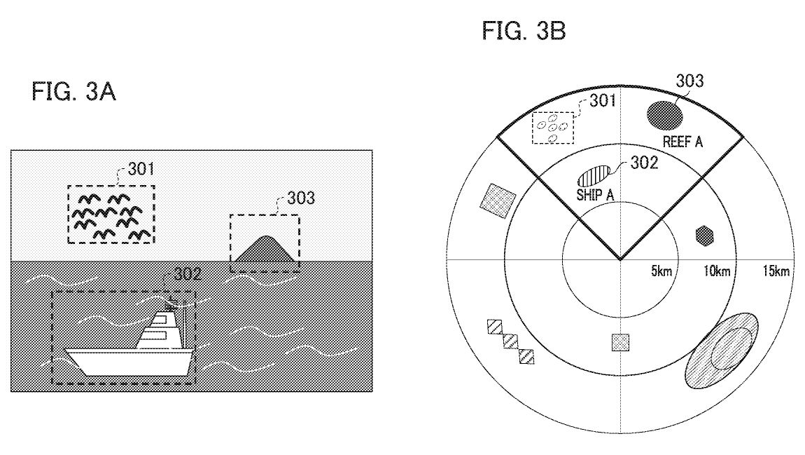

FIG. 3A is a diagram showing one example of a video image that has been acquired using the visible light camera 11. During image capturing by the visible light camera 11, if the weather is clear, as is shown in FIG. 3A, subject detection is possible for a group of seabirds 301, a ship 302, a reef 303, and the like. However, in a case in which there is a state in which there is fog, and haze, as is shown in the diagrams to be described below, the overall contrast for the video image is lowered, and there are cases in which the above-described subject detection is difficult with just information for visible light images for which haze correction processing has not been performed.

Please note that although the meanings of “fog/mist”, and “haze” are strictly different, the present disclosure uses the term “haze” and does not distinguish between these terms. In the present disclosure, “haze” means moisture (steam, rain, snow, and the like), sand, dust, pollen, and/or smoke, and the like, and in addition also refers to phenomena and conditions in which visibility is blurred, and it is not possible to see clearly due to moisture (steam, rain, snow, and the like), sand, dust, pollen, smoke, and the like. As examples of atmospheric obstacles other than haze, there is also heat haze, backlighting, and the like.

During step S202, the radar information acquisition unit 102 acquires subject information that has been measured by the radar 12.

The haze correction processing unit 103, the first detection unit 104, the degree of reliability calculating unit 106, and the subject identifying unit 107 specifically execute processing per each frame of images that configure a video image (a video). However, at least one of these functional units may also perform processing per specific number of frames such as two or more frames.

FIG. 3B shows a size, a bearing, a distance, vessel information, and nautical chart data for a subject that is obtained from the subject information that has been measured by the radar 12. The portion with the thick border in FIG. 3B is an angle corresponding to the visible light image in FIG. 3A, and it is possible to obtain the size, the bearing, and the distance information for each of the subjects such as the group of birds 301, the ship 302, and the reef 303.

During step S203, the haze correction processing unit 103 executes haze correction (tone correction) on the visible light images. Below, details of the haze correction processing will be explained.

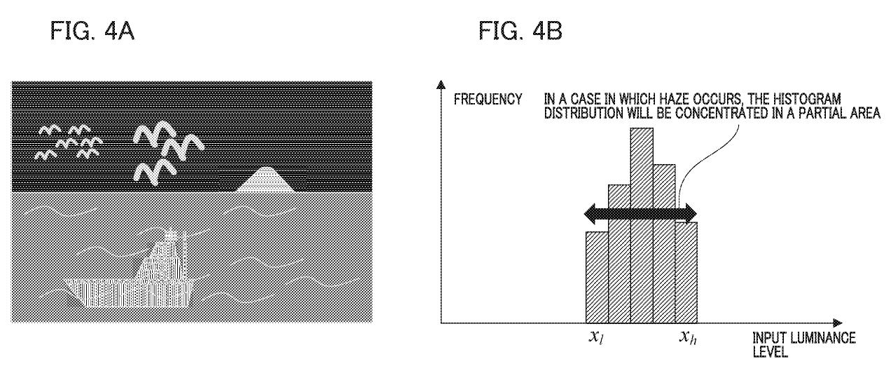

FIG. 4A shows an example of a visible light image of a state in which there is haze, and FIG. 4B shows a histogram of a state in which there is haze. In a state in which there is haze, the distribution of the histogram will be concentrated in one portion, the overall contrast of the image will be low, and it will become difficult to detect a subject. As is shown in the example of the histogram in FIG. 4B, in particular, the distribution of the input luminance level, which is the luminance value for the visible light image, is concentrated between xl – xh. An input luminance level in which the histogram distribution is concentrated in this manner may also be calculated by using a luminance value at which an accumulation value of the histogram becomes equal to or greater than a threshold value. For example, xl is a value for the input luminance level in which the frequencies of the input luminance levels have been added in order from lowest to highest, and the input luminance level has become greater than or equal to a predetermined threshold value. In addition, xh is a value for the input luminance level in which the frequencies of the input luminance levels have been added in order from highest to lowest and the input luminance level has become greater than or equal to a predetermined threshold value. The extent of such a concentration (and an extent of the dispersion) of the histogram distribution is one example of the strength of the effect of the atmospheric obstacle.

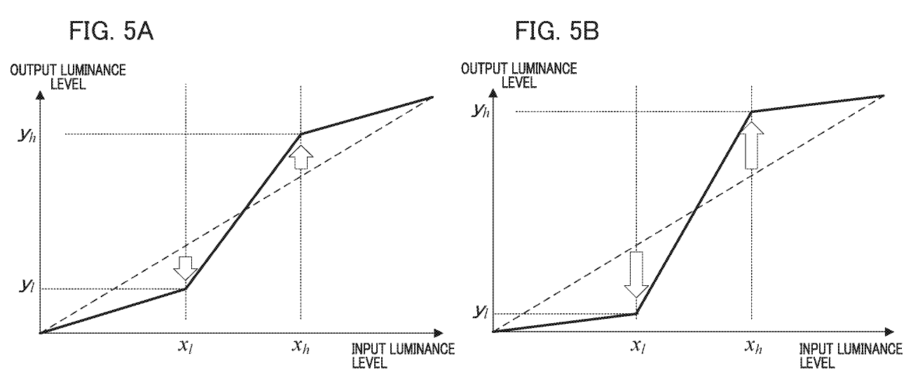

FIG. 5A, and FIG. 5B show examples of an input-output characteristic curve that is used in the haze correction (referred to below as a haze correction curve). The horizontal axis of the curve that is shown in FIG. 5A and FIG. 5B shows the input luminance level, and the vertical axis shows the output luminance level. The segment in which the histogram distribution for the input luminance is concentrated due to the effect of the haze (the segment above h1 and below xh) is set such that in the output luminance, the change from yl to yh is smooth. In this context, yl and yh are correction parameters that control the efficacy of the haze correction. That is, the correction parameters are one example of elements for controlling the effects of the atmospheric obstacle on the visible light image. The smaller that the value for yl is, and the larger that the value for yh is, the more effective the haze correction becomes, and higher contrast output results can be obtained. In comparison to FIG. 5A, the haze correction curve in FIG. 5B shows that the value for yl has been set so as to be small, and the value for yh has been set to be large, and that this is a haze correction curve with strong correction efficacy.

The above-described correction parameters may be configured so as to be set based on user commands, and so as to be set based on detection results for the histogram distribution as was described above. For example, the haze correction processing unit 103 may also have the correction parameters of “haze correction function”, and “haze correction strength” that are adjustable by the user. In the present embodiment, an example is given of a configuration in which the user is able to switch between options such as on/off for the haze correction function, and weak/strong for the haze correction strength as the correction parameters.

Note that it is sufficient if in a case in which the subject detection apparatus 100 automatically sets the correction strength based on the histogram distribution calculation results, the haze correction processing unit 103 performs the processing described below. The haze correction processing unit 103 is able to calculate the extent of the concentration of the histogram distribution based on, for example, a difference between of a total value for the luminance values for a range in which the accumulation value is equal to or greater than the threshold value and a total value for the luminance values of another range, a ratio of the luminance values for a range in which the accumulation value is equal to or greater than the threshold value and a total value for the luminance values of another range, and the like. However, the present disclosure is not limited thereto, and another method may also be used. For example, this may also be an average value not a total value.

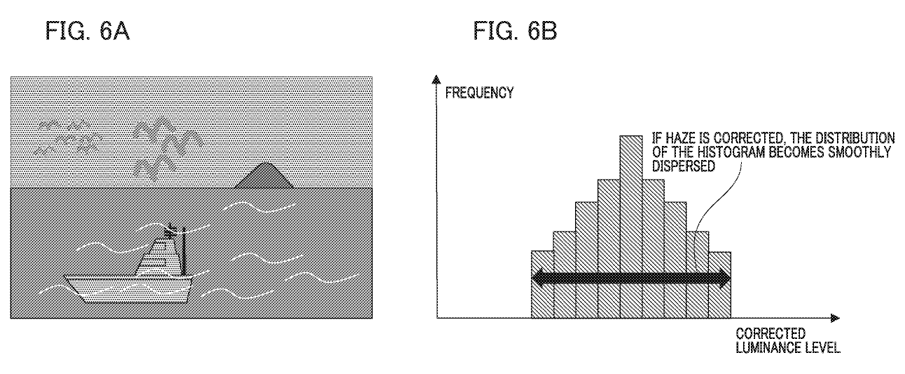

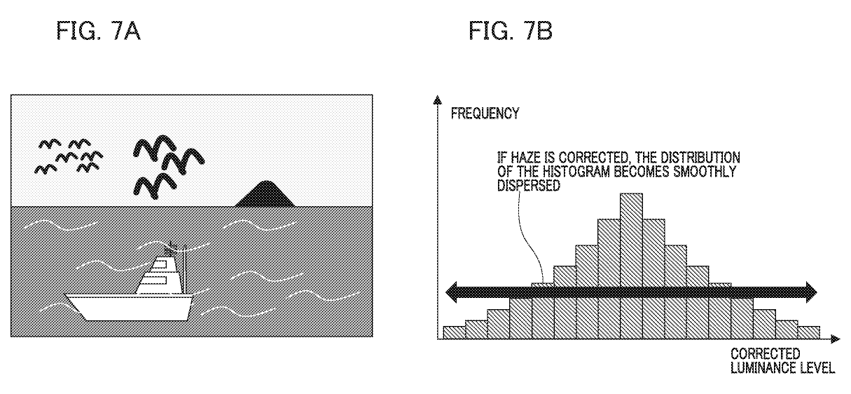

The haze correction processing unit 103 executes haze correction processing by applying the haze correction curve that has been calculated to the visible light images. FIG. 6A shows a video image from when a “haze correction function” has been turned “on”, and “weak” has been selected as the “haze correction strength”, and FIG. 6B shows a histogram from when a “haze correction function” has been turned “on”, and “weak” has been selected as the “haze correction strength.” FIG. 7A shows a video image from when a “haze correction function” has been turned “on”, and “strong” has been selected as the “haze correction strength”, and FIG. 7B shows a histogram from when a “haze correction function” has been turned “on”, and “strong” has been selected as the “haze correction strength”. The slope for the haze correction curve from when the “haze correction strength” is “strong” (for example, FIG. 5B) is larger than the slope for the haze correction curve from when the “haze correction strength” is “weak” (for example, FIG. 5A). In all of the video images, the distribution of the histogram becomes smooth in comparison to before the haze correction was executed, and all of the video images are corrected to video images having a light and dark contrast.

In this context, as a result of applying the haze correction curve, if the haze correction curve is a strong S-curve, in the same manner as when the haze correction strength is “strong”, subjects having deviations on the low luminance side will have the negative affect of underexposure (edge fall), and subjects having deviations on the high luminance side will have the negative affect of overexposure (white out). However, the contrast for subjects in a range of specific input luminance levels (equal to and greater than xl, and below xh) will be highly corrected. In contrast, if the haze correction curve is a gradual curve such as when the haze correction strength was “weak”, although the contrast range for the subjects will become limited, a video image can be obtained in which underexposure and overexposure have been suppressed. Therefore, a tradeoff due to the correction parameters is present in the effects of the haze correction that is explained in the present embodiment, and the parameters are dynamically changed according to the target and area that the user would like to observe.

The explanation will now return to the flowchart in FIG. 2. During step S204, the first detection unit 104 executes subject detection processing on the visible light image for which haze correction processing was executed during step S203. In this context, the first detection unit 104 of the present embodiment outputs an evaluation value that indicates the extent of the likelihood of being a subject for each subject that is a detection target. The evaluation value is output in a range of 0 to 100. The likelihood of being a subject is the degree of certainty for a subject that an object that is classified as this subject exists in this area.

During step S205, the second detection unit 105 executes subject detection processing on the radar information that was acquired during step S202. In this context, in the same manner as for step S204, the second detection unit 105 outputs an evaluation value in a range from 0 – 100 that indicates the extent of the likelihood of being a subject for each subject that is a detection target. In this context, as was explained above, the detection methods for the first detection unit 104 and the second detection unit 105 may be the same, and they may also be different. In the present embodiment, as an example, the first detection unit 104 uses a model that is configured to detect seabirds by using the features of shape and color. The second detection unit 105 uses a model that is configured to calculate a shape and size of seabirds that are detected by the radar 12 according to the movements and distances of the seabirds.

During step S206, the degree of reliability calculating unit 106 calculates a degree of reliability for the subject detection results. Specifically, the degree of reliability calculating unit 106 calculates a degree of reliability for the subject detection results that are obtained from the first detection unit 104, and a degree of reliability for the subject detection results that are obtained from the second detection unit 105. Below, the details of the degree of reliability calculation method for both of the subject detection results will be explained.

First, the characteristics of the radar, the visible light images, and the visible light images in which the haze correction processing has been performed will be explained.

As a characteristic of the radar, there is the characteristic that the radar 12 measures the microwaves that are reflected from the subject, and therefore, it is difficult for the radar 12 to be affected by haze, backlighting, and low illumination. However, the ability to analyze the azimuth angle is low, and there is the problem that it is difficult to identify the subject and its size.

In contrast, as a characteristic of the visible light images, although the subject detection precision decreases due to decreases in contrast and the occurrence of noise when the image capturing is performed when there is haze, backlighting, or at night, there is the advantage that it is possible to obtain high resolution color information. In addition, as the characteristics of the visible light images, even in a case in which haze occurs to a certain extent, it is possible to suppress decreases in the contrast for the subject, and to suppress decreases in the detection precision for subjects by executing the above-described haze correction processing.

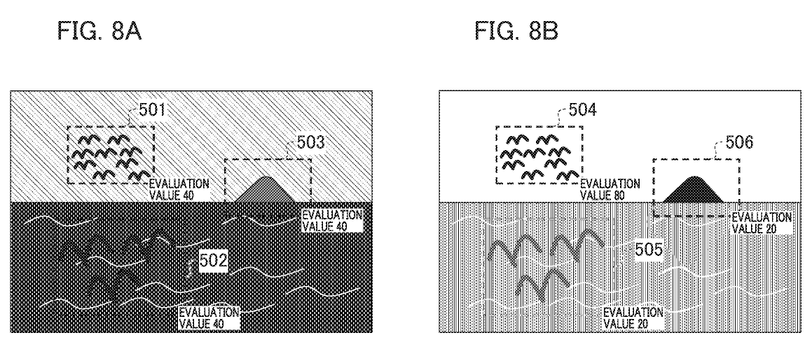

Next, the characteristics of the visible light images on which the haze correction processing has been performed will be explained. A characteristic of haze is that the farther away the distance until the subject is, the more that dispersion of the light occurs, and the subject contrast is lowered. Conversely, in a case in which the distance until the subject is close, the decrease in the subject contrast is limited. Therefore, in a case in which the haze correction strength is set to “strong”, although the effects of the haze are eliminated for far away subjects, the correction for nearby subjects has a greater effect than is necessary, and there are cases in which underexposure or overexposure occur. This will be explained with reference to FIG. 8 (A), and FIG. 8 (B).

FIG. 8A shows a video image from before haze correction processing for a state in which there is haze. FIG. 8B shows a video image after haze correction processing with a haze correction strength of “strong” has been executed. The evaluation values that are shown in FIG. 8A and FIG. 8B are evaluation values showing the extent of the likelihood of being a seabird for the far away seabirds 501 and 504, the nearby seabirds 502 and 505, and the far away reefs 503, and 506 for a case in which detection processing has been performed for seabirds. As is shown in FIG. 8A, in a case in which there is a state in which there is haze, and haze correction is not performed, all of the values for the evaluation values are low, and these are evaluation values such that even the identification between a seabird and a reef cannot be performed. In relation to this, as is shown in FIG. 8B, in a case in which strong haze correction is executed, the contrast for the far away subjects becomes higher in comparison to before the haze correction processing. In this case, the evaluation value for the far away seabird 504 becomes high, and the evaluation value for the far away reef 506 becomes low. In contrast, with respect to the nearby subjects, the ocean and the seabird 505 become underexposed due to excessive correction. Although conventionally, it is desirable for the evaluation value for the seabird 505 to become high, the evaluation value for the seabird 505 becomes low, and it is difficult to detect the seabird 505. The characteristics of the visible light images in which the above-described haze correction processing has been performed are referenced, and the degree of reliability calculating unit 106 calculates the degree of reliability for each subject.

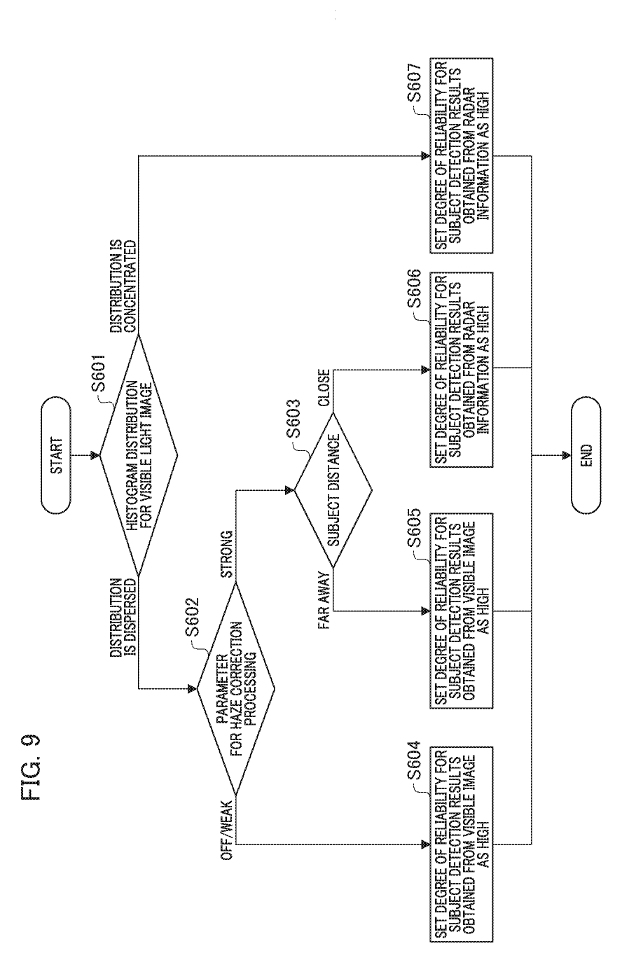

FIG. 9 is flowchart showing the calculation processing for the degree of reliability in the degree of reliability calculating unit 106 during step S206. In this context, the degree of reliability is made for example, a value of 0.0 – 1.0, and the degree of reliability is set such that the degree of reliability for the subject detection results for the visible light image and the degree of reliability for the subject detection results for the radar information become 1.0 when totaled together. In addition, the degree of reliability calculating unit 106 performs weighting on the two evaluation values, which are the detection results that are input, and uses the higher weighted result value. Note that in the explanation of the FIG. 9 below, the degree of reliability calculating unit 106 is referred to as a calculating unit for the sake of convenience.

During step S601, the calculating unit determines the histogram distribution for the visible light image. Note that in relation to the method for calculating the histogram distribution, as was explained in step S202, the histogram distribution may also be determined using a luminance value of a range in which an accumulation value of the histogram becomes equal to or greater than a threshold value. In a case in which the histogram distribution is dispersed, the processing proceeds to step S604, and in a case in which the histogram distribution is concentrated in one portion, the processing proceeds to step S607. Note that the histogram distribution is calculated in advance during the haze correction processing (step S203 of FIG. 2), and therefore, during step S601, the calculating unit may also use this calculation result.

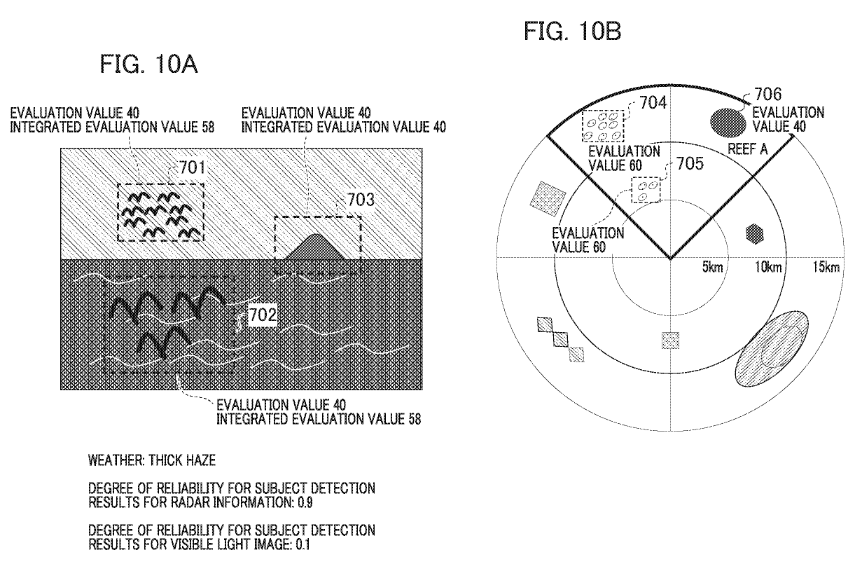

During step S607, in a case in which the distribution of the histogram is concentrated, the calculating unit sets the degree of reliability for the subject detection results that can be obtained from the radar information so as to be high. For example, the degree of reliability for the subject detection results for the radar information is set to 0.9, and the degree of reliability for the subject detection results for the visible light image is set to 0.1. FIG. 10A shows a state in which the overall subject detection results for the visible light image are low due to the effect of, for example, a thick haze (a thick fog). As is shown in FIG. 10, in conditions with a thick haze, even if the haze correction processing is executed, the contrast will not be restored (it will not become high), and the subject detection results for the visible light image will become low overall, and it won’t be possible to correctly identify subjects. In contrast, the radar information is not affected by weather such as haze and the like, and therefore, it is possible to stably obtain subject detection results such as those in FIG. 10B regardless of the weather. Therefore, in a case in which the distribution of the histogram for the visible light image is concentrated, by setting the degree of reliability for the subject detection results for the radar information in FIG. 10B to be high, it is possible to prevent subject information from being lost.

During step S602, the calculating unit determines later branching according to correction parameters for the haze correction processing that are obtained from the haze correction processing unit 103. In a case in which the “haze correction function is “off” and in a case in which the “haze correction function” is “on” and the “haze correction strength” is “low”, the processing proceeds to step S604. In addition, in a case in which the “haze correction function” is “on” and the “haze correction strength” is “high”, the processing proceeds to step S603.

The processing for step S602 is one example of a first determination relating to settings for the correction parameters during the correction processing. In this case, the haze correction strength being set to “strong” is one example of the correction parameter being set to a value that corresponds to a strength of an atmospheric obstacle that is greater than or equal to a predetermined strength. That is, a strength of an atmospheric obstacle that is greater than or equal to a predetermined strength is the extent of the concentration of the histogram distribution from when the haze is thick that is shown in FIG. 10 in the present embodiment. In addition, the haze correction strength being set to “weak” is one example of the haze correction strength being set to a value corresponding to a strength of the atmospheric obstacle that is less than a predetermined strength.

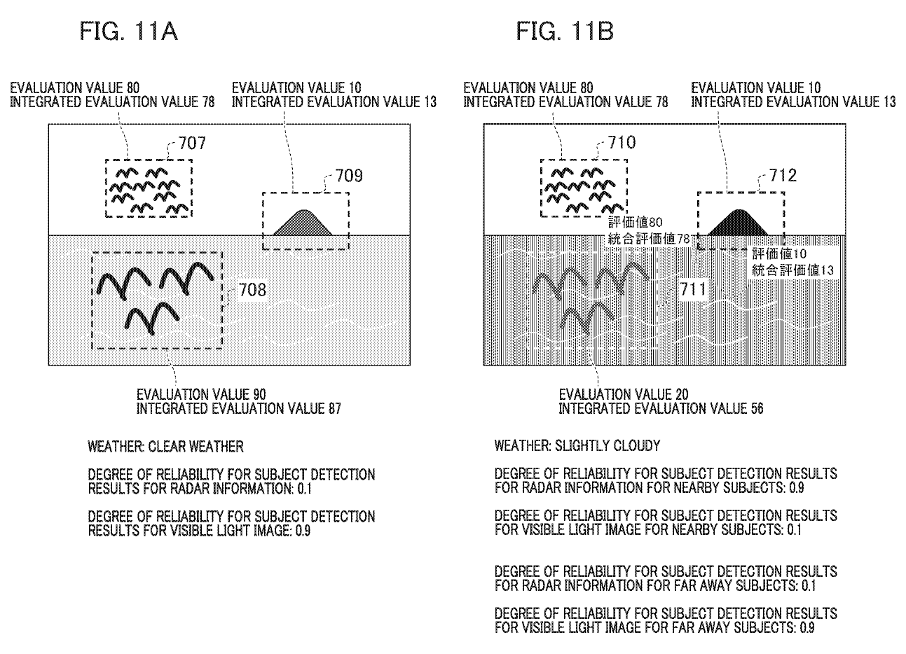

During step S604, the calculating unit sets the degree of reliability for the subject detection results that are obtained from the visible light image so as to be high. For example, the calculating unit sets the degree of reliability for the subject detection results for the visible light image as 0.9, and sets the degree of reliability for the subject detection results for the radar information as 0.1. FIG. 11A shows a video image of a state in which the histogram distribution for the visible light image is dispersed in conditions with clear weather, or a weak haze (the concentration of the haze is low). If there is clear weather or low haze conditions, even if the haze correction processing is not executed, the distribution of the histogram will be smoothly scatted, and there will be no negative effects. Therefore, in this case, the calculating unit performs the subject detection by using the high resolution color information from the visible light image. In addition, by setting the degree of reliability for the subject detection results for the visible light image so as to be high, it is possible to obtain subject detection results having the highest precision.

During step S603, the calculating unit makes the processing for the branching proceed according to the subject distance that is obtained from the subject detection results for the radar information. In a case in which the subject distance is far away, the processing proceeds to step S605, and in a case in which the subject distance is nearby, the processing proceeds to step S606. The processing for step S603 is one example of a second determination relating to a distance until the subject from among information relating to the subject.

The determination processing for step S603 may also be performed according to a user selection in the same manner as the determination processing for step 602. Conversely, the calculation unit may also be made so as to execute at least one of both of the determination processing for step S602 and the determination processing for step S603. In a case in which the calculating unit executes the determination processing for S603, it is sufficient if a threshold value is set for the subject distance, and the determination processing is executed based on this threshold value.

During step S605, the calculating unit sets the degree of reliability for the subject detection results that are obtained from the visible light image so as to be high. In addition, during step S606, the degree of reliability for the subject detection results that are obtained from the radar information is set to be high. FIG. 11B shows a video image of a state in which in conditions in which there is haze, strong haze correction processing is implemented, and the histogram distribution is dispersed. As is shown for the seabird 710 and the reef 712, haze eliminating effects are suitably performed by the haze correction processing on the far away subjects, and the evaluation value for the seabird becomes high, while the evaluation value for the reef becomes low. In contrast, although conventionally, in relation to nearby subjects, it is desirable for the evaluation value for the seabird 711 to become high, the evaluation value for the seabird 711 becomes low due to excessive correction. Therefore, the calculating unit sets the degree of reliability for the subject detection results for the visible image as high for the far away subjects for which the haze correction processing has been suitably performed, and sets the degree of reliability for the subject detection results for the radar information as high for the subjects that are nearby, for which excessive correction occurs. For example, in relation to far away subjects, the degree of reliability for the results for the visible light image is set to 0.9, and the degree of reliability for the results of the radar information is set to 0.1. In relation to nearby subjects, the degree of reliability for the results of the radar information is set to 0.9, and the degree of reliability for the results of the visible light image is set to 0.1.

By having the calculating unit perform the above explained step for all of the subject detection results, it becomes possible to calculate the degree of reliability that is proposed in the present embodiment.

Referring to FIG. 2, finally, during step S207, the subject identifying unit 107 calculates an integrated evaluation value and identifies subjects based on the subject detection results that have been obtained from the first detection unit 104, the subject detection results that have been obtained from the second detection unit 105, and the degrees of reliability for one or more subjects. In this context, the integrated evaluation value is a value that is obtained based on the degrees of reliability that have been calculated during step S206 for each subject in relation to the evaluation value for the visible light image and the evaluation value for the radar information. Specifically, as will be explained below, weighted addition is performed on the evaluation values.

For example, in FIG. 10A, the evaluation value for the subject detection results for the radar information is 0.9, and the evaluation value for the subject detection results for the visible light image is 0.1. In relation to the seabird 701 (704), the evaluation value for the visible light image is 40, and the evaluation value for the radar information is 60, and therefore, the integrated evaluation value for the seabird 701 (704) becomes 40×0.1+60×0.9=58. According to the same calculation method, the integrated evaluation value for the seabird 702 (705) is 58, and the integrated evaluation value for the reef 703 (706) is 40. In this manner, even in conditions in which it is difficult to identify a subject using the evaluation value for just the visible light image, a meaningful difference is created in the evaluation values, and identification becomes possible by referring to the evaluation values for the radar information.

As a method for identifying the subjects, for example, if an evaluation value for a subject that is obtained from the first detection unit 104 and an evaluation value for the subject that is obtained from the second detection unit 105 are greater than or equal to a threshold value, the subject identifying unit 107 can use the detection results for this subject as is. In a case in which the evaluation values for the subject are below the threshold value, the subject identifying unit 107 may also provide the user with information indicating that the subject has these evaluation values (low evaluation values). Conversely, it is possible to set two or more thresholds for the evaluation values, and for the subject identifying unit 107 to identify the subject using various well-known methods according to the evaluation values that are obtained from the first detection unit and the second detection unit.

In the same manner, in FIG. 11A, if the integrated evaluation values are calculated in the same manner, the integrated evaluation value for the seabird 707 becomes 78, the integrated evaluation value for the seabird 708 becomes 87, and the integrated evaluation value for the reef 709 becomes 13. It becomes possible to precisely identify subjects by placing importance on the degree of reliability for the subject detection for the visible light image at the time of clear weather such as that shown in FIG. 11A,

Furthermore, in FIG. 11B, the evaluation value for the subject detection results for the radar information for far away subjects is 0.1, and the evaluation value for the subject detection results for the visible light image for far away subjects is 0.9. In contrast, the evaluation value for the subject detection results for the radar information for nearby subjects is 0.9, and the evaluation value for the subject detection results for the visible light image for nearby subjects is 0.1. In this context, the evaluation value for the visible light image for the far away seabird 710 is 80, and the evaluation value for the radar information for the far away seabird 710 is 60 (FIG. 10), and therefore, the integrated evaluation value becomes 80×0.9+60×0.1=78. In contrast, the evaluation value for the visible light image for the nearby seabird 711 is 20, and the evaluation value for the radar information for the nearby seabird 711 is 60 (FIG. 10B), and therefore, the integrated evaluation value becomes 20×0.1+60×0.9=56. In addition, according to the same calculation method, the integrated evaluation value for the far away reef 712 becomes 13.

As has been explained above, although when using just the evaluation value for the visible light image after haze correction, the evaluation value for the nearby seabird was low, and there were conditions in which the nearby seabird could not be properly identified, it becomes possible to properly identify the subjects by using the haze correction strength and the subject detection results for the radar information.

In the technology in the above-explained Japanese Patent Laid-Open No. 2006-98614, there is no consideration given to the negative effects that occur in a case in which the parameters for use in the image processing (the luminance correction curve) were dynamically changed due to using these parameters, and there is a possibility that the detection will be overlooked, or an incorrect detection will occur. In relation to this, in the present embodiment, robust subject detection in an external environment is realized by calculating a degree of reliability for the subject detection based on the contents of correction by haze correction processing and subject information that is obtained from a source other than visible light. That is, according to the present embodiment, it is possible to appropriately perform subject detection processing.

### [Second Embodiment]

In the First Embodiment, an example was shown of a method in which the degree of reliability was calculated in the degree of reliability calculating unit 106 based on the strength information for the haze correction, and the distance information for the subjects that was obtained from the subject detection results from the radar information. In the Second Embodiment, an example will be explained of a method in which the degree of reliability is calculated based on the strength information for the haze correction, and noise information that is superimposed on the subjects and that is obtained from the subject detection results for the visible light image. Note that the same reference numerals will be applied to configurations that are the same as the configurations in the First Embodiment, and explanations thereof will be omitted.

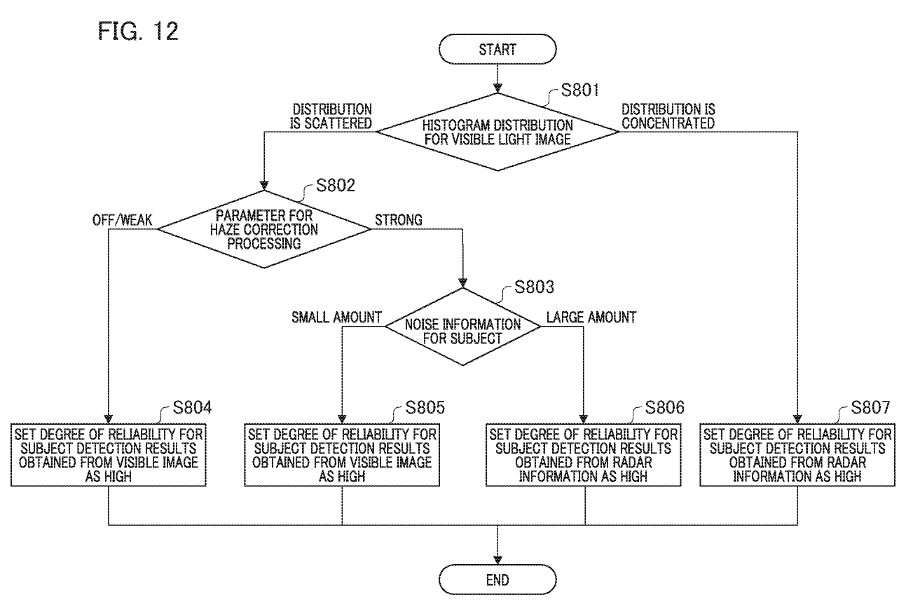

In the present embodiment, the flow from step S201 to step S205, and the flow for step S207 in FIG. 2 are the same as the processing for the First Embodiment, and therefore, explanations thereof will be omitted. FIG. 12 is a flowchart showing the calculation processing for the degree of reliability in the present embodiment. In FIG. 12, the processing other than the processing for step S803 is the same as the processing for the First Embodiment (step S602, step S602, and step S604 to step S607), and therefore, explanations thereof will be omitted.

The haze correction processing expands the signal, and therefore, it becomes such that the noise components are also expanded at the same time that the signal components for the subject image are expanded. Therefore, in conditions such as nighttime image capturing and the like in which a large amount of noise components is superimposed in comparison to the signal components, there are cases in which the noise is further amplified by the haze correction processing, and the subject detection abilities are decreased. In this case, as is shown in step S803, in a case in which strong haze correction processing is executed and there is a large amount of noise included, the calculating unit sets the degree of reliability for the subject detection results for the radar information as high. In contrast, in a case in which even if strong haze correction processing is performed, there is a small amount of noise, the calculating unit sets the degree of reliability for the subject detection results for the visible light image for which haze correction has been performed to be high. Note that the noise in the subject image is calculated from the subject detection results for the visible light image, and a variety of methods can be used such as methods that find the noise from the noise dispersion, a standard deviation, an average time bearing, and the like. The processing for step S803 is one example of a second determination relating to noise that is included in an image of the subject in the visible light image.

As has been explained above, in the present embodiment, it becomes possible to maintain the subject detection abilities even in a case in which haze correction processing has been executed at the time of nighttime image capturing by calculating the degree of reliability based on noise information that is superimposed on the subjects and that is obtained from the subject detection results for the visible light images.

Note that although in the present embodiment, an example has been explained of a method in which the evaluation value indicating the noise (whether there is a large or small amount of noise) is calculated from noise that is superimposed on an image, the present disclosure does not necessarily need to have such a configuration. For example, this may also be a configuration in which in a case in which a specific ISO setting has been reached based on predetermined information such as the information for noise characteristics, sensor size, and the like for a sensor for the visible light image, the ratio for the degrees of reliability is increased.

### [Other Embodiments]

In the above-described First Embodiment and Second Embodiment, an example has been given of information for the size, distance, and bearing of a subject that has been measured by the radar 12 to serve as the subject information (information relating to the subjects). However, the information relating to the subjects may also be information such as a temperature, a position, a speed, and the like of the subjects. These pieces of information can be measured using for example, a thermal camera, sonar, GNSS, AIS, and the like.

The subject detection apparatus 100 may also acquire external environment information such as weather information and the like. In this case, in addition to the correction contents for the haze correction processing unit 103, the degree of reliability calculating unit 106 may also calculate the degree of reliability further based on the external environment information that has been acquired. In this context, the weather information includes information such as a rainfall amount, a snowfall amount, and the like. For example, it is sufficient if in a case in which the rainfall amount or the snowfall amount is at or over a threshold value, the degree of reliability calculating unit 106 uses a degree of reliability that has been set to be low from the visible light image, and performs weighting on the evaluation values for the subject detection.

In the above-explained First Embodiment and Second Embodiment, the extent of the concentration or dispersion of the histogram distribution was given as an example of the information indicating the strength of the effect of the atmospheric obstacle. However, the information showing the strength of the atmospheric obstacle may also be a contrast value for the visible light image. In this case as well, the contrast value is the contrast value (contrast ratio) for the entire visible light image, and for each partial area of the visible light image. As the specific method, in a case in which the contrast value for the visible light image is low, the haze correction strength is set so as to be strong, and in a case in which the contrast value for the visible light image is high, the haze correction strength is sent to be low. Note that in case in which the contrast value is the contrast value for each partial area of the visible light image, it is sufficient if the haze correction processing is performed for each of these areas. The haze correction unit may also execute high pass filter processing and the like on the visible light image, and set the haze correction strength so as to become stronger the stronger the strength of the edge components is.

Conversely, the haze correction processing unit may also use a Dark Channel Prior method, which is a well-known haze removing method. In this case, the haze correction processing unit may also estimate an atmospheric transmissivity by calculating a dark channel value for each area of the visible light image, and set the haze correction strength so as to be stronger the higher the dark channel value is for an area. The estimation results for the atmospheric transmissivity are one example of information showing a strength of the effects of an atmospheric obstacle.

In the above-explained First Embodiment and Second Embodiment, the haze correction processing unit 103 executed the correction processing for the entirety of the visible light image, and for each area thereof. However, the haze correction processing unit 103 may also calculate the strength of the effects of the atmospheric obstacle for each area of the visible light image, and execute correction only for the portion of the areas for which the strength of the effects of this atmospheric obstacle is equal to or greater than the threshold value.

Although in the above-explained First Embodiment and Second Embodiment, the two stages of “strong” and “weak” were given as the settings for the haze correction strength during the haze correction processing, this may also be made three or more stages. For example, during S602, it may be made possible to set four stages of correction parameters, “off”, “weak”, “medium”, and “strong”, and it may also be possible to set the degree of reliability in two stages, and three or more stages according to these correction parameters. In the same manner, the parameters of “far away” and “nearby” during step S603 (FIG. 9), and S803 (FIG. 12) may also be made three or more stages instead of the two stages of “far away” and “nearby”.

The subject detection apparatus 100 may also be able to provide the user with an image in which the subjects that have been detected have been displayed as being emphasized. As examples of displaying this as being emphasized, there is, for example, adding color to the subject, surrounding the subject with a rectangle or lines in another shape, a display of a specific image that indicates the subject (for example, an arrow), and the like. This specific image may also be displayed so as to flash, and the subject image itself may also be displayed so as to flash. The subject detection apparatus 100 may also generate an image including an emphasized display that is different according to the degree of reliability that has been calculated by the degree of reliability calculating unit 106.

It may also be made such that at least one of the visible camera 11 and the radar 12 are embedded in the same housing as the subject detection apparatus 100.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-221590, filed December 18, 2024, which is hereby incorporated by reference herein in its entirety.

What is claimed is:

1. A subject detection apparatus comprising:
one or more memories storing instructions; and
one or more processors executing the stored instructions, causing the one or more processors to:
acquire a visible light image including subject;
acquire information that is different than the visible light image and relates to the subject;
perform correction on an area that has been affected by an atmospheric obstacle among the visible light image;
perform a first detection for the subject from the visible light image;
perform a second detection for the subject from the information relating to the subject;
calculate a degree of reliability for detection result for the first detection that has been performed on the visible light image that has been corrected, and a degree of reliability for detection result for the second detection; and
identify the subject based on the detection result for the first detection, the detection result for the second detection, and the degrees of reliability that have been calculated.

2. The subject detection apparatus according to claim 1,
wherein the one or more processors executes the stored instructions, causing the one or more processors to further:
perform the correction based on a histogram distribution for luminance values of the visible light image.

3. The subject detection apparatus according to claim 1, wherein the one or more processors executes the stored instructions, causing the one or more processors to further:
perform the correction based on a contrast value for the visible light image.

4. The subject detection apparatus according to claim 1,
wherein the one or more processors execute the stored instructions, causing the one or more processors to further:
perform the correction based on estimation result for atmospheric transmissivity using a Dark Channel Prior Method.

5. The subject detection apparatus according to claim 1,
wherein the one or more processors executes the stored instructions, causing the one or more processors to further:
perform a first determination relating to a setting for a correction parameter of the correction in order to control effects of the atmospheric obstacle on the visible light image.

6. The subject detection apparatus according to claim 5,
wherein the one or more processors executes the stored instructions, causing the one or more processors to further:
perform a second determination relating to a distance until the subject from among information relating to the subject.

7. The subject detection apparatus according to claim 5,
wherein the one or more processors executes the stored instructions, causing the one or more processors to further:
perform a second determination relating to noise that is included in image of the subject in the visible light image.

8. The subject detection apparatus according to claim 6,
wherein the one or more processors executes the stored instructions, causing the one or more processors to further:
perform the second determination in a case in which during the first determination, it was determined that the correction parameter had been set to a value corresponding to a strength of the effects of the atmospheric obstacle that is greater than or equal to a predetermined strength.

9. The subject detection apparatus according to claim 6,
wherein the one or more processors execute the stored instructions, causing the one or more processors to further:
set the degree of reliability for the result of the first detection to be larger than a degree of reliability for the result of the second detection in a case in which during the first determination, it has been determined that the correction parameter has been set to a value corresponding to a strength that is less than a predetermined strength of the effects of the atmospheric obstacle.

10. The subject detection apparatus according to claim 6,
wherein the one or more processors executes the stored instructions, causing the one or more processors to further:
set the degree of reliability for the results of the second detection to be higher than the degree of reliability for the results of the first detection in a case in which during the second determination, the distance until the subject was less than a threshold value.

11. The subject detection apparatus according to claim 6,
wherein the one or more processors execute the stored instructions, causing the one or more processors to further:
set the correction parameter based on an instruction from a user.

12. The subject detection apparatus according to claim 1,
wherein the information relating to the subject is at least one of a size of the subject, a bearing of the subject, a position of the subject, and a distance until the subject.

13. The subject detection apparatus according to claim 1,
wherein the one or more processors executes the stored instructions, causing the one or more processors to further:
acquire external environmental information; and
calculate the degree of reliability based on the external environment information that has been acquired.

14. The subject detection apparatus according to claim 1,
wherein the one or more processors executes the stored instructions, causing the one or more processors to further:
perform correction on an area that has been affected by haze among the visible light images that have been affected by haze.

15. A method executed by a subject detection apparatus, the method comprising: acquiring a visible light image including subject;
acquiring information that is different than the visible light image and relates to the subject ;
performing correction on an area that has been affected by an atmospheric obstacle among the visible light image;
performing a first detection for the subject from the visible light images;
performing a second detection for the subject from the information relating to the subject;
calculating a degree of reliability for detection result for the first detection that has been performed on the visible light image that has been corrected, and a degree of reliability for detection result for the second detection; and
identifying the subject based on the detection results for the first detection, the detection result for the second detection, and the degrees of reliability that have been calculated.

16. A non-transitory storage medium storing a control program of a subject detection apparatus, causing a computer to perform each step of a method for the subject detection apparatus, the method comprising:
acquiring a visible light image including subject;
acquiring information that is different than the visible light image and relates to the subject ;
performing correction on an area that has been affected by an atmospheric obstacle among the visible light image;
performing a first detection for the subject from the visible light images;
performing a second detection for the subject from the information relating to the subject;
calculating a degree of reliability for detection result for the first detection that has been performed on the visible light image that has been corrected, and a degree of reliability for detection result for the second detection; and
identifying the subject based on the detection results for the first detection, the detection result for the second detection, and the degrees of reliability that have been calculated.
